(19) United States
(12) Patent Application Publication
(10) Pub. No.: US 2026/0122656 A1
(43) Pub. Date: Apr. 30, 2026

(54) POWER CONTROL FOR SIDELINK PHYSICAL SIDELINK FEEDBACK CHANNEL TRANSMISSION

(71) Applicant: Nokia Technologies Oy, Espoo (FI)

(72) Inventors: Timo Erkki LUNTTILA, Espoo (FI); Jari Olavi LINDHOLM, Espoo (FI); Torsten WILDSCHEK, Gloucester (GB); Naizheng ZHENG, Beijing (CN); Renato Barbosa ABREU, Aalborg (DK); Nuno Manuel KIILERICH PRATAS, Aalborg (DK); Jian Guo LIU, Shanghai (CN); Yong LIU, Shanghai (CN); Thomas Haaning JACOBSEN, Aalborg (DK)

(21) Appl. No.: 19/471,665

(22) PCT Filed: Apr. 5, 2023
(86) PCT No.: PCT/CN2023/086366

§ 371 Date: Oct. 1, 2025

(51) Int. Cl. H04W 72/25; H04W 52/14

(52) U.S. Cl. CPC H04W 72/25; H04W 52/14

(57) ABSTRACT

Systems, methods, apparatuses, and computer program products for determining the transmit power for a common interlace and RBs. One method may include a UE determining a PSFCH allocation for at least one dedicated RB, calculating a corresponding transmission power of the PSFCH allocation for the at least one dedicated RB, and determining an allocation of common PSFCH RBs. The method further include, based upon the transmission power for the dedicated resource blocks and the determined number of common resource block, calculating transmission power for the common RBs.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for determining the transmit power for a common interlace and resource blocks (RBs).

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (UE) (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include determining, by a UE, a physical sidelink feedback channel allocation for at least one dedicated physical sidelink feedback channel resource block. The method may further include calculating, by the UE, a corresponding transmission power of the physical sidelink feedback channel allocation for the at least one dedicated physical sidelink feedback channel resource block. The method may further include determining, by the UE, an allocation of common physical sidelink feedback channel resource blocks. The method may further include based upon the corresponding transmission power and the determined number or allocation of the plurality of common physical sidelink feedback channel resource blocks, calculating, by the UE, transmission power for the plurality of common physical sidelink feedback channel resource blocks.

In accordance with certain example embodiments, an apparatus may include means for determining a physical sidelink feedback channel allocation for at least one dedicated physical sidelink feedback channel resource block. The apparatus may further include means for calculating a corresponding transmission power of the physical sidelink feedback channel allocation for the at least one dedicated physical sidelink feedback channel resource block. The apparatus may further include means for determining an allocation of common physical sidelink feedback channel resource blocks. The apparatus may further include means for, based upon the corresponding transmission power and the determined number or allocation of the plurality of common physical sidelink feedback channel resource blocks, calculating transmission power for the plurality of common physical sidelink feedback channel resource blocks.

In accordance with various example embodiments, a non-transitory computer readable medium may include program instructions that, when executed by an apparatus, cause the apparatus to perform at least a method. The method may include determining a physical sidelink feedback channel allocation for at least one dedicated physical sidelink feedback channel resource block. The method may further include calculating a corresponding transmission power of the physical sidelink feedback channel allocation for the at least one dedicated physical sidelink feedback channel resource block. The method may further include determining an allocation of common physical sidelink feedback channel resource blocks. The method may further include, based upon the corresponding transmission power and the determined number or allocation of the plurality of common physical sidelink feedback channel resource blocks, calculating transmission power for the plurality of common physical sidelink feedback channel resource blocks.

In accordance with some example embodiments, a computer program product may perform a method. The method may include determining a physical sidelink feedback channel allocation for at least one dedicated physical sidelink feedback channel resource block. The method may further include calculating a corresponding transmission power of the physical sidelink feedback channel allocation for the at least one dedicated physical sidelink feedback channel resource block. The method may further include determining an allocation of common physical sidelink feedback channel resource blocks. The method may further include, based upon the corresponding transmission power and the determined number or allocation of the plurality of common physical sidelink feedback channel resource blocks, calculating transmission power for the plurality of common physical sidelink feedback channel resource blocks.

In accordance with certain example embodiments, an apparatus may include at least one processor and at least one memory storing instructions that, when executed by the at least one processor, cause the apparatus at least to determine a physical sidelink feedback channel allocation for at least one dedicated physical sidelink feedback channel resource block. The at least one memory and instructions, when executed by the at least one processor, may further cause the apparatus at least to calculate a corresponding transmission power of the physical sidelink feedback channel allocation for the at least one dedicated physical sidelink feedback channel resource block. The at least one memory and instructions, when executed by the at least one processor, may further cause the apparatus at least to determine an allocation of common physical sidelink feedback channel resource blocks. The at least one memory and instructions, when executed by the at least one processor, may further cause the apparatus at least to, based upon the corresponding transmission power and the determined number or allocation of the plurality of common physical sidelink feedback channel resource blocks, calculate transmission power for the plurality of common physical sidelink feedback channel resource blocks.

In accordance with various example embodiments, an apparatus may include determining circuitry configured to determine a physical sidelink feedback channel allocation for at least one dedicated physical sidelink feedback channel resource block. The apparatus may further include calculating circuitry configured to calculate a corresponding transmission power of the physical sidelink feedback channel allocation for the at least one dedicated physical sidelink feedback channel resource block. The apparatus may further include determining circuitry configured to determine an allocation of common physical sidelink feedback channel resource blocks. The apparatus may further include calculating circuitry configured to, based upon the corresponding transmission power and the determined number or allocation of the plurality of common physical sidelink feedback channel resource blocks, calculate transmission power for the plurality of common physical sidelink feedback channel resource blocks.

### BRIEF DESCRIPTION OF THE DRAWINGS

For a proper understanding of example embodiments, reference should be made to the accompanying drawings, wherein:

FIG. 1 illustrates an acquisition of a channel occupancy time by an initiating device via listen before talk type 1;

FIG. 2(a) illustrates listen before talk type 2C, where the gap is between two transmissions both from an initiating UE;

FIG. 2(b) illustrates listen before talk type 2B, where the gap is between two transmissions both from an initiating UE;

FIG. 2(c) illustrates listen before talk type 2A, where the gap is between two transmissions both from an initiating UE;

FIG. 2(d) illustrates listen before talk type 2C, where the gap is between two different transmissions from an initiating UE and a responding UE, correspondingly;

FIG. 2(e) illustrates listen before talk type 2B, where the gap is between two different transmissions from an initiating UE and a responding UE, correspondingly;

FIG. 2(f) illustrates listen before talk type 2A, where the gap is between two different transmissions from an initiating UE and a responding UE, correspondingly;

FIG. 3 illustrates a scenario of a responding device needing to acquire a new channel occupancy time;

FIG. 4(a) illustrates sidelink resource allocation mode 1;

FIG. 4(b) illustrates sidelink resource allocation mode 2;

FIG. 5 illustrates an example of a sidelink slot structure;

FIG. 6 illustrates sidelink slots with physical sidelink control channel/physical sidelink shared channel and physical sidelink feedback channel;

FIG. 7 illustrates a physical sidelink shared channel to physical sidelink feedback channel mapping;

FIG. 8 illustrates an interlaced frequency division multiplex scheme for a new radio uplink;

FIG. 9(a) illustrates a quasi-uniform interlace frequency division multiplexing physical sidelink feedback channel for NR-unlicensed (subcarrier spacing 15 KHz) with a set of RBs for a secondary physical sidelink feedback channel;

FIG. 9(b) illustrates a quasi-uniform interlace frequency division multiplexing physical sidelink feedback channel for NR-unlicensed (subcarrier spacing 15 KHz) with UE1 physical sidelink feedback channel primary and secondary interlace;

FIG. 9(c) illustrates a quasi-uniform interlace frequency division multiplexing physical sidelink feedback channel for NR-unlicensed (subcarrier spacing 15 KHz) with UE2 physical sidelink feedback channels primary and secondary interlace;

FIG. 10 illustrates an example of 20 MHz bandwidth with 15 kHz subcarrier spacing in which interlace 1 (i.e., RBs 1, 11, 21, . . . , 91) may be used as common interlaced by 5 UEs, and RBs 4, 15, 83, 94 and 97 may be used as dedicated RBs for each UE;

FIG. 11 illustrates power allocation when applying various example embodiments described herein;

FIG. 12 illustrates an example of allocation of common and dedicated RBs for physical shared feedback channel according to some example embodiments;

FIG. 13 illustrates an example of a flow diagram of a method that may be performed by a UE according to various example embodiments;

FIG. 14 illustrates an example of various network devices according to some example embodiments; and

FIG. 15 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for determining the transmit power for a common interlace and RBs is not intended to limit the scope of certain example embodiments, but is instead representative of selected example embodiments.

Enhancements to sidelink (SL) operations in 3GPP may include support of SL on unlicensed spectrum for both mode 1 and mode 2 where Uu operation for mode 1 may be limited to licensed spectrum only. Channel access mechanisms from NR-U may be reused for SL unlicensed (SL-U) operations; this may assess the applicability of SL resource reservation to SL-U operations within the boundaries of unlicensed channel access mechanism and operations.

The physical channel design framework may include changes to NR SL physical channel structures and procedures to operate on unlicensed spectrum; for example, an existing NR SL and NR-U channel structure may be reused as the baseline.

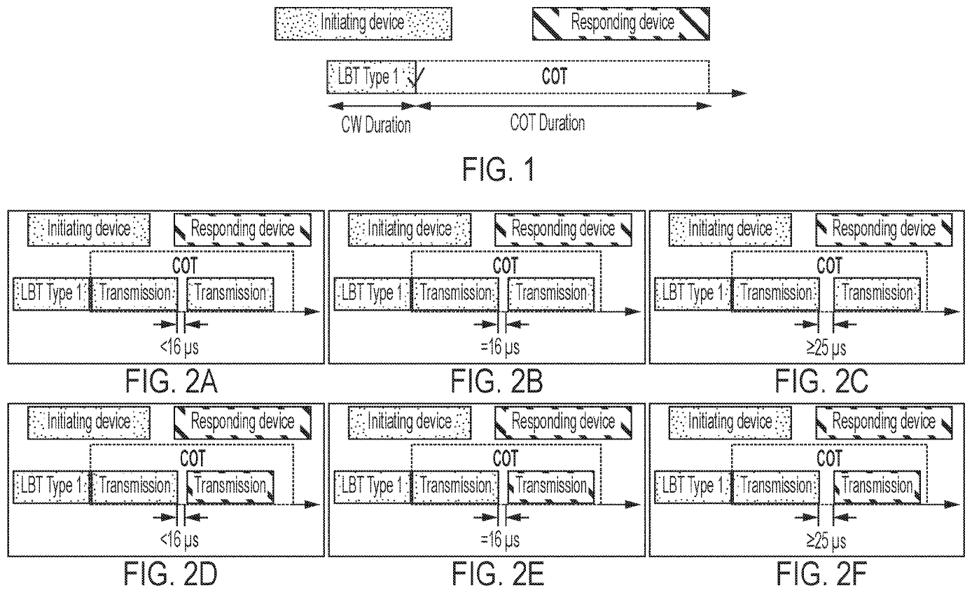

In sub-7 GHz unlicensed bands, coexistence of NR with other systems (e.g., Institute of Electrical and Electronics Engineers (IEEE) 802.11) may be possible with a listen before talk (LBT) channel access mechanism, where a UE intending to perform a SL transmission may first be required to successfully complete an LBT check before initiating transmission. In order for a UE to pass an LBT check, the UE may need to first observe the available channel for a number of consecutive clear channel assessment (CCA) slots; in sub-7 GHz, the duration of these slots is 9 μs. The UE may deem the channel as available in a CCA slot if the measured power (i.e., the energy collected during the CCA slot) is below a regulatory specified threshold, which may depend on the operating band and geographical region. When a UE initiates the communication (i.e., acting as an initiating device), the UE may acquire the “right” to access the channel for a certain period of time (i.e., channel occupancy time (COT)) by applying an “extended” LBT procedure where the channel may be deemed as free for the entire duration of a contention window (CW). This “extended” LBT procedure may be referred to as LBT Type 1, as illustrated in FIG. 1.

The duration of both the COT and CW may depend on a channel access priority class (CAPC) associated with traffic of the UE's traffic, such as in Table 1 below. Control plane traffic (e.g., physical sidelink control channel (PSCCH)) may be transmitted with p=1, while user plane traffic may be p>1. Table 1 provides details of LBT type 1 for the Uu uplink (UL) case; however, downlink (DL) case LBT type 1 parameters may also be adopted in SL.

TABLE 1
CAPC for UL

| CAPC | | | | | |
|---|---|---|---|---|---|
| (p) | mₚ | CW_{min, p} | CW_{max, p} | T_{ulm cot, p} | Allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, 255, |
| | | | | 10 ms | 511, 1023} |
| 4 | 7 | 15 | 1023 | 6 ms or | {15, 31, 63, 127, 255, |
| | | | | 10 ms | 511, 1023} |

Upon successfully completing the LBT Type 1 and performing a transmission, the UE initiating the transmission (as the initiating device) may acquire the COT with a duration associated with the corresponding CAPC. The acquired COT may be valid even when the initiating device pauses its transmission. However, if the initiating device wants to perform a new transmission (e.g., within the COT), the initiating device may still be required to perform a “reduced” LBT procedure (e.g., “LBT Type 2”). For example, LBT Type 2A (i.e., 25 μs LBT), as illustrated in FIGS. 2(c) and (f), may be used for SL transmissions within the initiating device acquired COT when the gap between two SL transmissions is ≥25 μs, as well for SL transmissions following another SL transmission. In another example, FIGS. 2(b) and (e) illustrate LBT Type 2B (i.e., 16 μs LBT) that may be used for SL transmissions within the initiating device acquired COT, and may only be used for SL transmissions following another SL with gap exactly equal to 16 μs. In a further example, LBT Type 2C (i.e., no LBT) (illustrated in FIGS. 2(a) and (d)) may only be used for SL transmission following another SL, with a gap <16 μs, and the allowed duration of the SL transmission ≤584 μs.

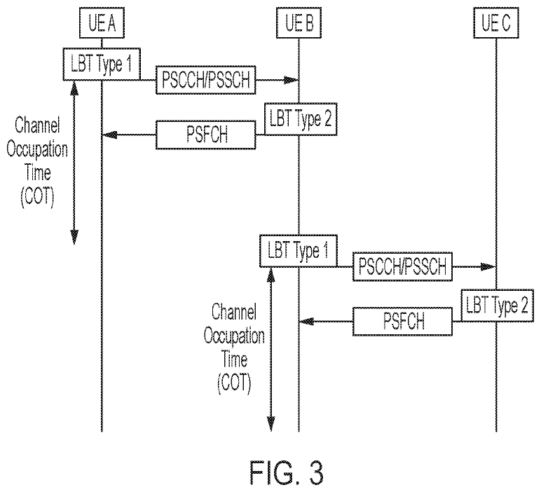

An initiating device may share its acquired COT with its intended receiver (i.e., the responding device). As illustrated in FIG. 3, the initiating device may notify (e.g., via control signaling) the responding device about the duration of this COT. The responding device may then use this information to decide which type of LBT it should apply upon performing a transmission for which the intended receiving device is the initiating device. If the responding device transmission falls outside the COT, the responding device may acquire a new COT using the LBT Type 1 with the appropriate CAPC.

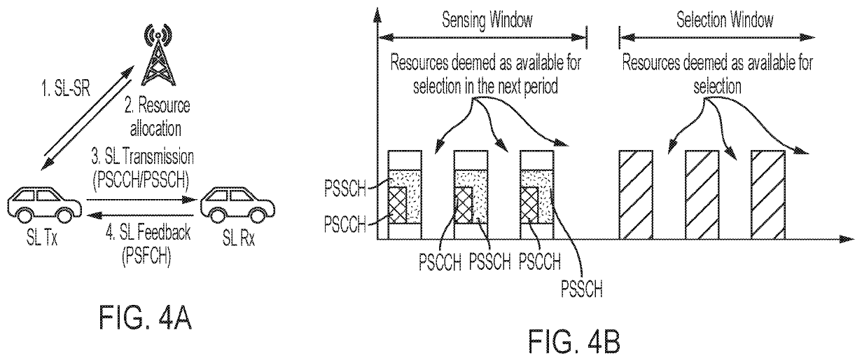

In 3GPP Rel-16, NR SL may facilitate a UE to communicate with other nearby UE via direct/SL communication. Two resource allocation modes may be used (i.e., NR SL mode 1 and NR SL mode 2), and a SL transmitter (TX) UE may be configured with one of them to perform NR SL transmissions. In NR SL mode 1, a SL transmission resource may be assigned (scheduled) by the network to the SL TX UE, as depicted in FIG. 4(a). In contrast, a SL TX UE in NR SL mode 2 may autonomously select its SL transmission resources, as depicted in FIG. 4(b). In NR SL mode 1, where the base station is responsible for the SL resource allocation, the configuration and operation may be similar to the one over the Uu interface.

In NR SL mode 2, the SL UEs may autonomously perform the resource selection with the aid of a sensing procedure. Specifically, a SL TX UE in NR SL mode 2 may first perform a sensing procedure over the configured SL transmission resource pools in order to determine the reserved resources of other nearby SL TX UE. Based on the data obtained from sensing, the SL TX UE may select resources from the available SL resources, accordingly. In order for a SL UE to perform sensing and obtain the necessary information to receive a SL transmission, the SL UE may need to decode the SL control information (SCI).

SCI associated with a data transmission may include 1^{st}-stage SCI and 2^{nd}-stage SCI. In general, SCI may follow a 2-stage SCI structure to support the size difference between the SCIs for various NR-vehicle-to-everything (V2X) SL service types (e.g., broadcast, groupcast and unicast). The 1^{st} stage SCI (i.e., SCI format 1-A) may be carried by PSCCH, and may contain information to enable sensing operations and/or information needed to determine resource allocation of the physical sidelink shared channel (PSSCH) and to decode 2^{nd} stage SCI. The 2^{nd} stage SCI (i.e., SCI format 2-A and 2-B) may be carried by PSSCH (e.g., multiplexed with SL-shared channel (SCH)), and may contain source and destination identities, information to identify and decode the associated SL-SCH transport block (TB), control of hybrid automatic repeat request (HARQ) feedback in unicast/groupcast, and/or triggers for channel state information (CSI) feedback in unicast.

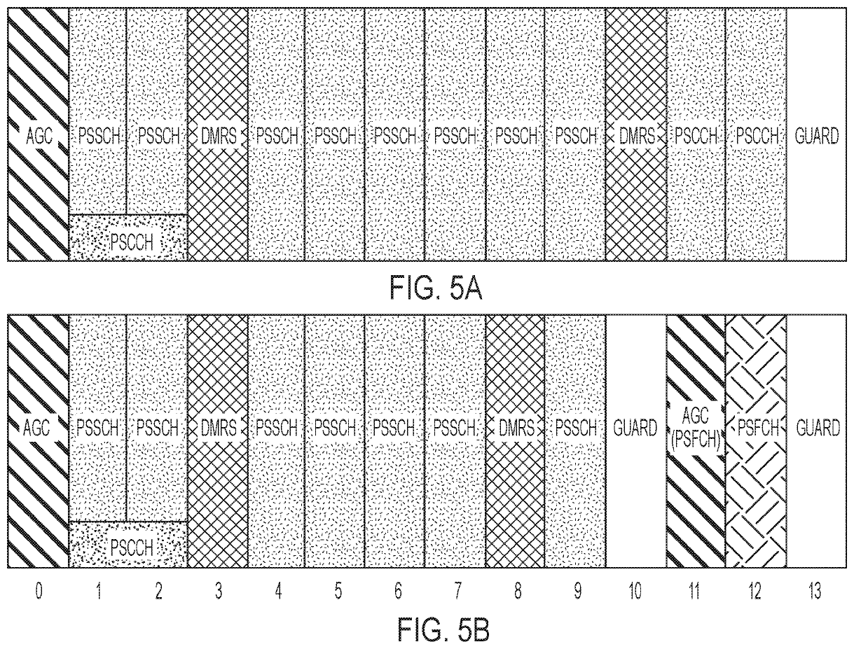

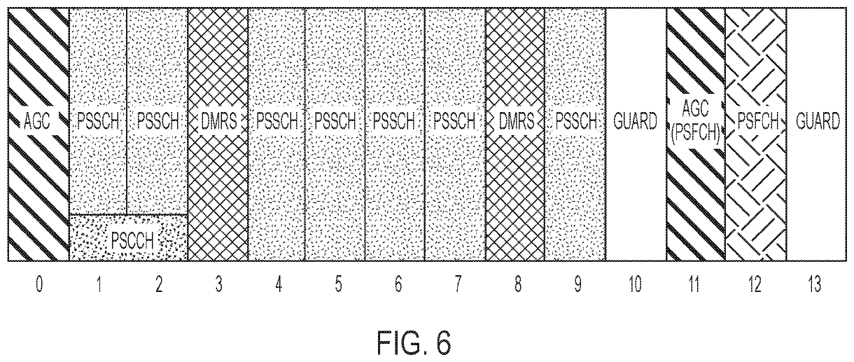

The configuration of the resources in the SL resource pool may define the minimum information required for a RX UE to be able to decode a transmission, which may include the number of sub-channels, the number of physical resource blocks (PRBs) per sub-channels, the number of symbols in the PSCCH, which slots have a physical sidelink feedback channel (PSFCH), and/or other configuration aspects. However, data for actual SL transmission (i.e., the payload) may be provided in the PSCCH (i.e., 1^{st} stage SCI) for each individual transmission, which may include the time and frequency resources, the demodulation reference signal (DMRS) configuration of the PSSCH, the modulation and coding scheme (MCS), PSFCH, and/or others. FIG. 5 depicts an example of the SL slot structure, illustrated as a slot with PSCCH/PSSCH and a slot with PSCCH/PSSCH where the last symbols are used for PSFCH.

The configuration of the PSCCH (e.g., DMRS, MCS, number of symbols used) may be part of the resource pool configuration. Furthermore, the indication of which slots have PSFCH symbols may also be part of the resource pool configuration. However, the configuration of the PSSCH (e.g., the number of symbols used, the DMRS pattern, and the MCS) may be provided by the 1^{st} stage SCI, which may be the payload sent within the PSCCH, and may follow the configuration shown in Table 2 below.

TABLE 2
PSSCH DMRS configurations based on the number
of used symbols and duration of the PSCCH

| | DMRS position l̅ | | | | | |
|---|---|---|---|---|---|---|
| | PSCCH duration 2 symbols | | | PSCCH duration 3 symbols | | |
| l_{d} in | Number of PSSCH DMRS | | | Number of PSSCH DMRS | | |
| symbols | 2 | 3 | 4 | 2 | 3 | 4 |
| 6 | 1, 5 | — | | 1, 5 | | |
| 7 | 1, 5 | — | | 1, 5 | | |
| 8 | 1, 5 | — | | 1, 5 | | |
| 9 | 3, 8 | 1, 4, 7 | — | 4, 8 | 1, 4, 7 | |
| 10 | 3, 8 | 1, 4, 7 | — | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

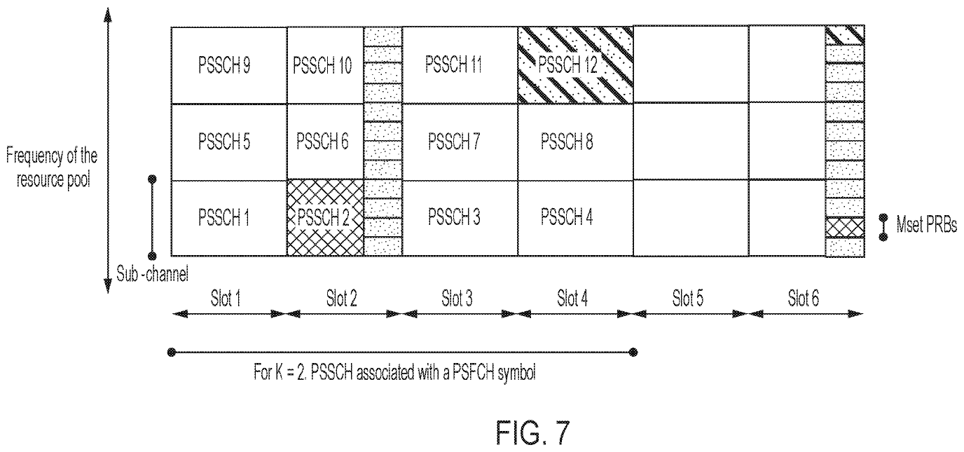

3GPP Rel-16 introduced PSFCH in order to enable HARQ feedback over the SL from a UE that is the intended recipient of a PSSCH transmission (i.e., the RX UE) to the UE that performed the transmission (i.e., the TX UE). Within a PSFCH, a Zadoff-Chu sequence in one PRB may be repeated over two orthogonal frequency division multiplexing (OFDM) symbols, the first of which can be used for automatic gain control (AGC), near the end of the SL resource in a slot. An example slot format of PSCCH, PSSCH, and PSFCH is shown in FIG. 7; the Zadoff-Chu sequence when used as a base sequence may be pre-configured per SL resource pool.

The time resources for PSFCH may be pre-configured to occur once every 0, 1, 2, or 4 slots. The HARQ feedback resource (i.e., PSFCH) may be derived from the resource location of PSCCH/PSSCH. Configuration parameter K with the unit of slot may be used for PSSCH-to-HARQ timing. The time occasion for PSFCH may be determined from K. For a PSSCH transmission with its last symbol in slot n, HARQ feedback may be in slot n+a, where a may be the smallest integer larger than or equal to K with the condition that slot n+a contains PSFCH resources. The time gap of at least K slots may allow for consideration of the RX UE's processing delay when decoding the PSCCH and generating the HARQ feedback. K can be equal to 2 or 3, and a single value of K may be pre-configured per resource pool. This may allow several RX UEs using the same resource pool to utilize the same mapping of PSFCH resources for the HARQ feedback. With the parameter K, the N PSSCH slots associated with a slot with PSFCH may be determined.

As in the example shown in FIG. 7, the period of PSFCH resources may be configured as N=4 (i.e., 4 PSSCH slots associated with the PSFCH), and K (e.g., sl-MinTimeGapPSFCH) may be configured as 2. With L sub-channels in a resource pool, and N PSSCH slots associated with a slot containing PSFCH, there may then be N*L sub-channels associated with a PSFCH symbol. With M PRBs available for PSFCH in a PSFCH symbol, there may be M PRBs available for the HARQ feedback of transmissions over N*L sub-channels.

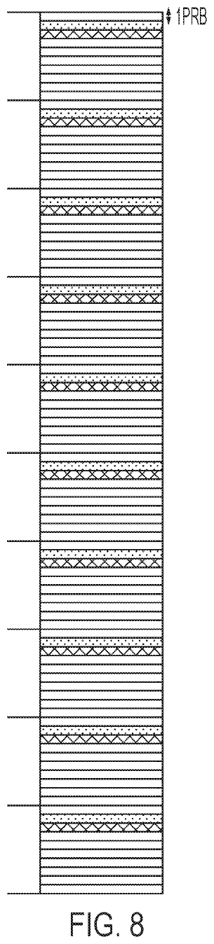

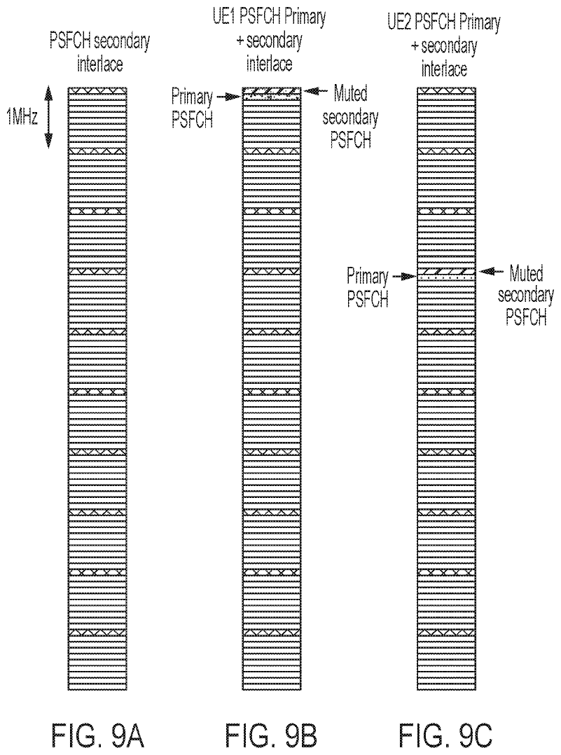

With M configured to be a multiple of N*L, a distinct set of Mₛₑₜ=M/(N*L) PRBs may be associated with the HARQ feedback for each sub-channel within a PSFCH period. The first set of Mₛₑₜ PRBs among the M PRBs available for PSFCH may be associated with the HARQ feedback of a transmission in the first sub-channel in the first slot. The second set of Mₛₑₜ PRBs may be associated with the HARQ feedback of a transmission in the first sub-channel in the second slot and so on. This is illustrated in FIG. 8 with N=4, L=3, and with all PRBs in a PSFCH symbol available for PSFCH. The HARQ feedback for a transmission at PSSCH x may be sent on the set x of Mₛₑₜ PRBs in the corresponding PSFCH symbol, with x=1, . . . , 12.

A set of Mₛₑₜ PRBs associated with a sub-channel may be shared among multiple RX UEs in case of acknowledgement (ACK)/negative acknowledgement (NACK) feedback for groupcast communications (option 2) or in the case of different PSSCH transmissions in the same sub-channel. For each PRB available for PSFCH, there may be Q cyclic shift pairs available to support the ACK or NACK feedback of Q RX UEs within the PRB. For a resource pool, the number of cyclic shift pairs Q may be pre-configured and may equal 1, 2, 3, or 6.

The number F of PSFCH resources available may be computed, in relation to cyclic shift (CS) of a sequence (e.g., Zadoff-Chu sequence), to support the HARQ feedback of a given transmission (e.g.,

$${R}_{P R B , C S}^{P S F C H} ) .$$

With each PSFCH resource used by one RX UE, F available PSFCH resources may be used for the ACK/NACK feedback of up to F RX UEs.

The F PSFCH resources available for multiplexing the HARQ feedback for the PSSCH may be determined based on two options. Firstly, based on the L PSSCH sub-channels used by a PSSCH, F may be computed as F=L PSSCH*Mₛₑₜ*Q PSFCHs (associated with the L PSSCH sub-channels of a PSSCH), with L PSSCH sub-channels of a PSSCH, Mₛₑₜ PRBs for PSFCH associated with each sub-channel, and Q cyclic shift pairs available in each PRB. Secondly, F PSFCH resources may be determined based only on the starting sub-channel used by a PSSCH (i.e., based only on one sub-channel for the case when L PSSCH>1), according to F=Mₛₑₜ*Q PSFCHs (associated with the starting sub-channel of a PSSCH), with Mₛₑt PRBs for PSFCH associated with each sub-channel, and Q cyclic shift pairs available in each PRB. Similarly to the PUCCH in 3GPP Rel-15 NR Uu, the available F PSFCH resources may be indexed based on a PRB index (i.e., frequency domain) and a cyclic shift pair index (i.e., code domain).

The mapping of the PSFCH index i (i=1,2, . . . , F) to the PRBs and to the Q cyclic shift pairs may be such that the PSFCH index i first increases with the PRB index until reaching the number of available PRBs for PSFCH. The PSFCH index i may then increase with the cyclic shift pair index, again with the PRB index and so on. Among the F PSFCHs available for the HARQ feedback of a given transmission, an RX UE may select for its HARQ feedback the PSFCH with index i given by i=(T_{ID}+R_{ID})mod F, where T_{ID} is the Layer 1 ID of the TX UE (indicated in the 2nd-stage SCI). R_{ID}=0 for unicast ACK/NACK feedback and groupcast NACK-only feedback (i.e., option 1).

For groupcast ACK/NACK feedback (i.e., option 2), R_{ID} may be equal to the RX UE identifier within the group, which may be indicated by higher layers. For a number X of RX UEs within a group, the RX UE identifier may be an integer between 0 and X−1. An RX UE may determine which PRB and cyclic shift pair should be used for sending its HARQ feedback based on the PSFCH index i. The RX UE may use the first or second cyclic shift from the cyclic shift pair associated with the selected PSFCH index i in order to send NACK or ACK, respectively. By RX UEs selecting PSFCHs with index i, a TX UE may distinguish the HARQ feedback of different RX UE(s) (via the RX UE identifier, for example, for groupcast option 2), and the HARQ feedback intended for the TX UE (via the Layer 1 ID of the TX UE, e.g., for unicast). As R_{ID}=0 for groupcast option 1, the RX UEs may select the same PSFCH index i for their NACK-only feedback based solely on the Layer 1 ID TX UE identifier T_{ID}.

The PSFCH may be transmitted in response to the reception of a PSCCH/PSSCH transmission (e.g., when the receiver is the intended receiver), and therefore may be an associated PSFCH power control procedure. The UE may perform multiple PSFCH transmissions in the same slot, and each one may be a narrowband transmission.

With respect to PSFCH power control procedure, as discussed below, when the UE operates under network coverage, and the dl-P0-PSFCH is provided, the power control may be towards the serving cell, and may be based on the number of PSFCH transmission in the same slot rather than on the required power towards the intended receiver. When the UE operates outside network coverage or the dl-P0-PSFCH is not provided (e.g., the SL resource pool takes place in resources not shared with Uu's UL), the power control may only depend on the number of PSFCH transmissions in the same slot, and may not be limited by the pathloss to the gNB and related interference to the UL reception at the gNB. Thus, if the UE only has to perform one PSFCH transmission and no dl-P0-PSFCH is provided (i.e., no need to do power control towards the serving cell), the UE may apply maximum transmission power given by P_{cmax}.

NR in unlicensed spectrum is limited to below 7 GHz bands. At this frequency range, certain spectrum requirements may exist for the design of UL physical channels, for example, that occupied channel bandwidth (OCB) shall be between 80% and 100% of the declared nominal channel bandwidth. The OCB may be the bandwidth containing 99% of the power of the signal. During a COT, equipment may operate temporarily with an OCB of less than 80% of its nominal channel bandwidth with a minimum of 2 MHz. Requirements on the maximum power spectral density (PSD) may have a resolution bandwidth of 1 MHz, and require a maximum PSD of 10 dBm/MHz for 5150-5350 MHz. 10 KHz resolution may be required for testing the 1 MHz PSD constraint; thus, the maximum PSD constraint may be met in any occupied 1 MHz bandwidth. In addition, a band specific total maximum transmission power may be required, such as an effective isotropic radiated power (EIRP) limit of 23 dBm for 5150-5350 MHz.

The limitations in terms of OCB and PSD may affect design choices for the UL channels of NR-unlicensed systems, such as an interlaced frequency division multiplexing (FDM) scheme shown in FIG. 8. In this interlaced FDM (e.g., UL resource allocation type 2), the UL resources may be allocated in interlaces of 10 equidistant PRBs. The number of interlaces may be 10 for 15 kHz subcarrier spacing (SCS), and 5 for 30 kHz SCS.

HARQ feedback may be transmitted over the PSFCH in response to the reception of a PSCCH/PSSCH transmission when the receiver is the intended receiver. The required transmission power may be calculated according to the PSFCH power control procedure, as described above. However, similar to all transmissions on n46 (i.e., 5200 MHz), n96 (i.e., 6000 MHz), and n102 (i.e., 6200 MHz) bands, the PSFCH transmission may also comply with OCB and PSD regulations, as discussed above.

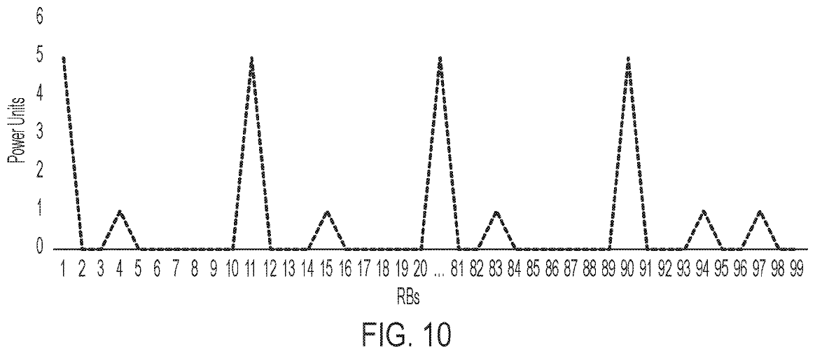

Various options may affect PSFCH transmission with 15 kHz and 30 kHz SCS. For example, a first option may require that each PSFCH transmission occupies 1 common interlace and K3 dedicated PRBs, which may address the problem that arises with the PSFCH when applying interlaced FDM in SL-U in order to meet the OCB and PSD requirement. This technique may use a common interface (e.g., PSFCH secondary interface as illustrated in FIG. 10) with any information to meet the OCB requirements, and transmit HARQ feedback in a dedicated RB (e.g., “PSFCH Primary” in FIG. 10). Another may require that each PSFCH transmission occupies 1 interlace and apply PRB-level cyclic shift; a UE may transmit a dedicated cyclic shift on K1 dedicated PRBs within this interlace, and transmit common cyclic shift on other PRBs of this interlace. Other options may require that each PSFCH transmission occupies 1 dedicated interlace and/or adopt PRB-level cyclic shift hopping as in NR-U. In addition, some options may require that each PSFCH transmission occupies K4 dedicated PRBs and K2 common PRBs, where K2 common PRBs are located at the two edges of an RB set. This technique may be similar to previously mentioned techniques, but instead of transmitting an interlace of common RBs, the common RBs may only be sent on each edge of the channel (i.e., RB set). For example, as illustrated in FIG. 10, only the uppermost and the lowermost red RBs would be transmitted. However, these options do not address the impact of PSD limits (e.g., whether/how to operate when common PRB and dedicated PRB locate within the same 1 MHz bandwidth, for example, dropping common PRB or reduce power on common PRB in such case).

The fact that each UE uses a common interlace or common RBs, and one or more dedicated RBs for the PSFCH transmission means that the common interlace/RBs may be used by multiple UEs. As a result, the power in such a common interlace may linearly increase with the number of UEs that need to transmit HARQ feedback, while the power of the dedicated RB may be smaller. This may result in additional, unnecessary interference that could interfere with the operation of other devices on the same spectrum, and also unnecessarily increase power consumption. Thus, it is preferable to avoid using more TX power for the common interlace/RBs than what is required. FIG. 10 illustrates an example of 20 MHz bandwidth with 15 kHz SCS in which interlace 1 (i.e., RBs 1, 11, 21, . . . , 91) may be used as common interlace by 5 UEs, and RBs 4, 15, 83, 94 and 97 may be used as dedicated RBs for each UE. As shown in FIG. 10, if each UE transmits its dedicated and common RBs with the same power, the total power transmitted on the common RBs may be five times as large as the power on the dedicated RBs. This may cause interference to other UEs in the vicinity and/or may impact the decoding of the information transmitted on the dedicated RBs due to large power imbalance between dedicated and common RBs.

Certain example embodiments described herein may have various benefits and/or advantages to overcome the disadvantages described above. For example, certain example embodiments may satisfy requirements for OCB and PSD are met, while minimizing power consumed, and interference caused, by the UE. Thus, certain example embodiments discussed below are directed to improvements in computer-related technology.

As described below, some example embodiments relate to power control enhancements that enable UEs to comply with OCB and PSD requirements for PSFCH transmission, while keeping the interference caused by the transmissions on the common interlaces or RBs as low as possible. In this way, interference to other devices and networks operating in the vicinity may be minimized.

For example, in various example embodiments, a UE may determine, according to SL power control procedures, the TX power applied for the dedicated PSFCH RBs (i.e., TxP_ded). When the UE transmits multiple PSFCHs simultaneously, the TxP_ded of each transmission may be the same as in 3GPP R16/R17, and/or the TxP_ded of some PSFCHs may be reduced to meet the PSD limit in an unlicensed spectrum.

Next, the UE may determine the number of common PSFCH RBs that are all non-adjacent (i.e., N_RB_corn). The common PSFCH RBs may form an interlace, a partial interlace, and/or be located on the upper and/or the lower edge of an RB set. The transmission of common PSFCH RBs that are located close to dedicated PSFCH RBs (e.g., within 1 MHz) may be omitted.

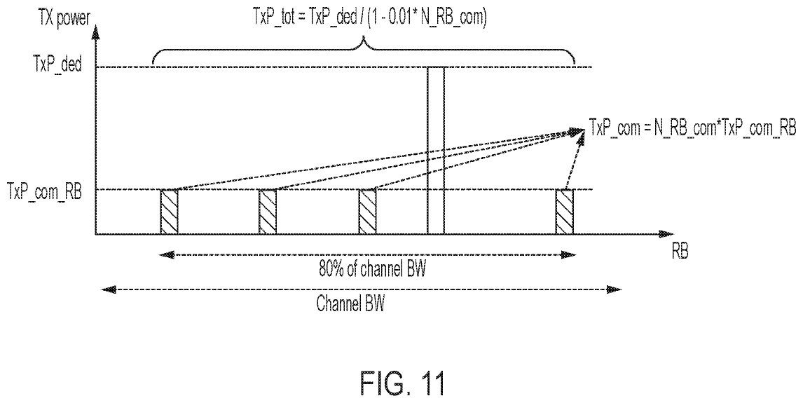

The UE may then select the TX power TxP_com for the common PSFCH RBs, wherein at least 99% of the total PSFCH energy (i.e., dedicated+common PSFCH RBs) may be allocated for RBs that span at least 80% of the nominal channel bandwidth. In case of a 20-MHz channel, the OCB (e.g., bandwidth from the lowest allocated RB to the highest allocated RB) may be at least 16 MHz. If the dedicated PSFCH RB allocation already meets the OCB requirement, TxP_com may be set to zero (i.e., common PSFCH RBs are not transmitted). FIG. 11 depicts power allocation for certain example embodiments with common PSFCH interlace/RBs. Specifically, TxP_tot is the total PSFCH transmit power, TxP_ded is the power for the dedicated PSFCH RB, TxP_com_RB is the power of each common PSFCH RB, TxP_com is the total power for common PSFCH RBs, and N_RB_com is the number of common PSFCH RBs.

TxP_com may be calculated in a few different ways. For example, each PSFCH transmission may occupy K4 dedicated PRBs and K2 common PRBs, where K2 common PRBs may be located at the two edges of a RB set, K4=1, and K2=2 (one RB on each edge of the RB set). For a nominal channel BW of 20 MHz, occupied channel BW may be at least 16 MHz (i.e., ceil(16 MHz/0.18 MHz)=89 RBs for 15 kHz SCS), and ceil(16 MHz/0.36 MHz)=45 RBs for 30 kHz SCS.

After the dedicated RB is transmitted with power level TxP_ded, in order to meet the OCB requirement, at least 99% of the signal must have a BW of 16 MHz. Thus, the power on each one of the common RBs (TxP_com) that are located at least 16 RBs apart should be more than 1% of the total TX power (i.e., TxP_com>TxP_ded/0.98−TxP_ded). Similarly, for a case with a common interlace of 10 RBs where all common RBs have the same TX power, the TX power of the common RBs may be calculated as xP_com>TxP_ded/0.90−TxP_ded. Correspondingly, the total Tx power may be calculated as TxP_tot=TxP_ded+TxP_com=TxP_ded/(1−0.01*N_RB_com). Additionally, a safety margin (e.g., multiplier) may be added into the TxP_com formula to accommodate, for example, measurement and RF inaccuracy. The safety margin can be, for example, a fixed number, such as 3 dB.

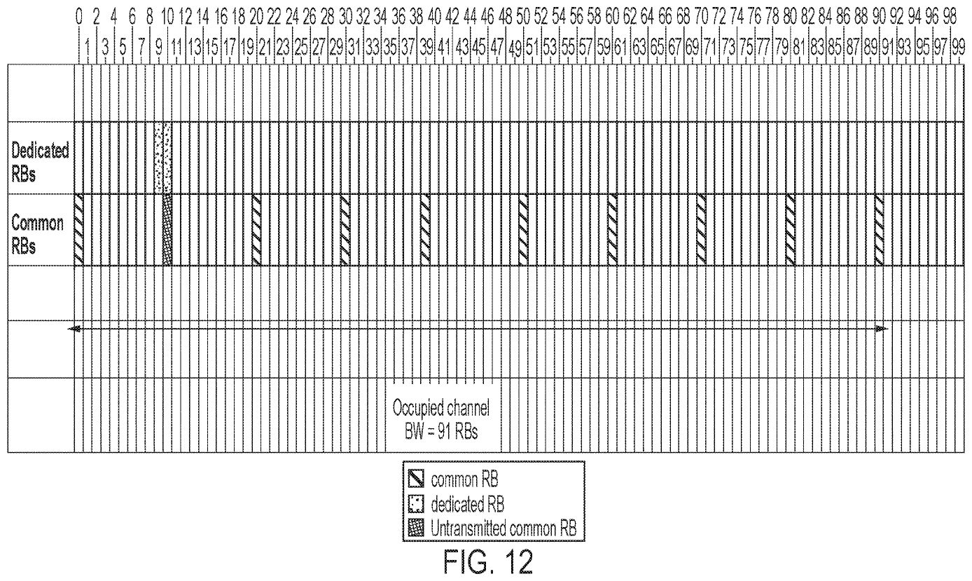

FIG. 12 depicts an example with each PSFCH transmission occupying 1 common interlace and K3 dedicated PRBs, with K3=2 dedicated RBs, and an interlace of 10 equidistant common RBs. However, the common RB #10, which overlaps with a dedicated RB is not transmitted, leaving in total 9 common RBs. Therefore, in this scenario, the TX power of the common RBs may be calculated as

$$TxP\_com > TxP\_ded / ( 1 - 0.01 * 9 ) - TxP\_ded = TxP\_ded / 0.91 - TxP\_ded .$$

Consequently, if the dedicated RBs were transmitted with the maximum power allowed by the PSD rule (e.g., 10 dBm (i.e., 10 mW)), the power of the dedicated RBs must satisfy, without assuming a further safety margin: TxP_com>10 mW/0.91−10 mW=0,989 mw, −0 dBm.

In various example embodiments, the power reduction that is applied to PSFCH in common interlace may be used to increase the PSFCH power in the dedicated RB. Specifically, PSFCH power may be divided equally between all the transmitted PSFCHs in the same slot. PSFCH power in common interlace may then be reduced as described in any of the options described above. The power of PSFCH in the dedicated RB may then be increased so that the total TX PSFCH power is the same as in the first step.

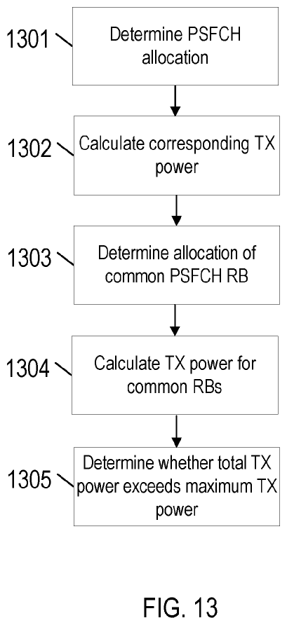

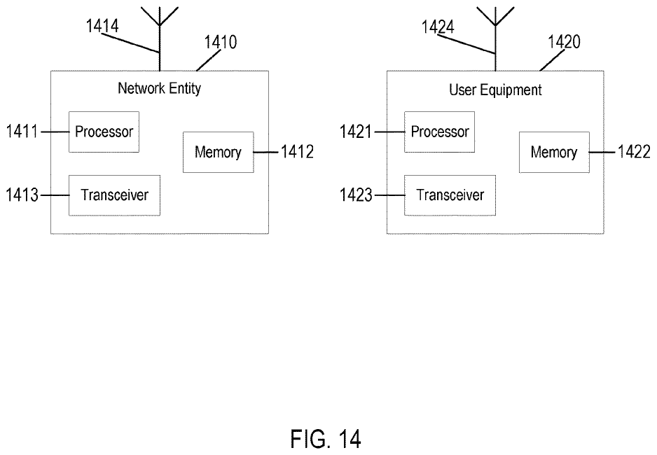

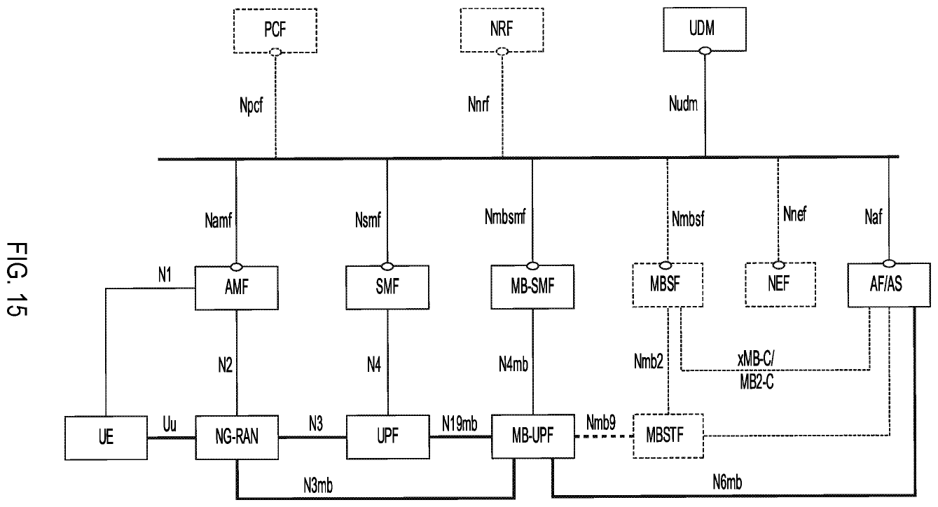

FIG. 13 illustrates an example of a flow diagram of a method that may be performed by a UE, such as UE 1420 illustrated in FIG. 14, according to various example embodiments.

At 1301, the method may include determining a PSFCH allocation for at least one PSFCH dedicated RB.

At 1302, the method may further include calculating a corresponding TX power of the PSFCH allocation for the at least one dedicated PSFCH RB. For example, the power may be calculated following the SL power control procedures.

At 1303, the method may further include determining at least one of a number or an allocation of a plurality of common PSFCH RBs. As an example, the determining the allocation of common PSFCH RB may include omitting the transmission of common RBs that are located closer to the dedicated PSFCHs RBs than a threshold; such a threshold may be defined to be, for example, 1 MHz, and/or in terms of number of RBs. Furthermore, the determining the allocation of common PSFCH RB may include verifying whether or not the PSFSC RB allocation already meets the OCB requirement; as a result, common RBs may not be transmitted.

At 1304, the method may further include calculating the TX power for the plurality of common RBs based upon the corresponding TX power calculated at 1302, and the determined number or allocation of the plurality of common PSFCH RBs determined at 1303. For example, the TX power may be calculated according to

$$TxP\_com > TxP\_ded / ( 1 - 0.01 * N\_RB \_com ) - TxP\_ded + Safety Margin .$$

At 1305, the method may further include determining whether the calculated total transmit power (TxP_com+TxP_ded) exceeds the UE's maximum TX power P_{cmax}. If TxP_com+TxP_ded>P_{cmax}, but TxP_ded<P_{cmax}, the method may include omitting the transmission of common RBs that are not the outermost ones (i.e., closest to the edges of the channel/RB set). Otherwise, if omitting the transmission of common RBs that are not the outermost ones is not possible, or enough to reduce the total TX power below P_{cmax}, the method may include reducing both TxP_com and TxP_ded by an equal amount until the total power is equal to or smaller than P_{cmax}.

FIG. 14 illustrates an example of a system according to certain example embodiments. In one example embodiment, a system may include multiple devices, such as, for example, NE 1410 and/or UE 1420.

NE 1410 may be one or more of a base station (e.g., 3G UMTS NodeB, 4G LTE Evolved NodeB, or 5G NR Next Generation NodeB), a serving gateway, a server, and/or any other access node or combination thereof.

NE 1410 may further include at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5^{th} generation core (5GC).

UE 1420 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1410 and/or UE 1420 may be one or more of a citizens broadband radio service device (CBSD).

NE 1410 and/or UE 1420 may include at least one processor, respectively indicated as 1411 and 1421. Processors 1411 and 1421 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1412 and 1422. The memory may be fixed or removable. The memory may include computer program instructions or computer code contained therein. Memories 1412 and 1422 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1411 and 1421, memories 1412 and 1422, and any subset thereof, may be configured to provide means corresponding to the various blocks of FIG. 13. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 14, transceivers 1413 and 1423 may be provided, and one or more devices may also include at least one antenna, respectively illustrated as 1414 and 1424. The device may have many antennas, such as an array of antennas configured for multiple input multiple output (MIMO) communications, or multiple antennas for multiple RATs. Other configurations of these devices, for example, may be provided. Transceivers 1413 and 1423 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIG. 13). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIG. 13. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

FIG. 15 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 15 may be similar to NE 1410 and UE 1420, respectively. The user plane function (UPF) may provide services such as intra-RAT and inter-RAT mobility, routing and forwarding of data packets, inspection of packets, user plane quality of service (QoS) processing, buffering of DL packets, and/or triggering of DL data notifications. The application function (AF) may primarily interface with the core network to facilitate application usage of traffic routing and interact with the policy framework.

According to certain example embodiments, processors 1411 and 1421, and memories 1412 and 1422, may be included in or may form a part of processing circuitry or control circuitry. In addition, in some example embodiments, transceivers 1413 and 1423 may be included in or may form a part of transceiving circuitry.

In some example embodiments, an apparatus (e.g., NE 1410 and/or UE 1420) may include means for performing a method, a process, or any of the variants discussed herein. Examples of the means may include one or more processors, memory, controllers, transmitters, receivers, and/or computer program code for causing the performance of the operations.

In various example embodiments, apparatus 1420 may be controlled by memory 1422 and processor 1421 to determine a physical sidelink feedback channel allocation for at least one dedicated PSFCH RB; calculate a corresponding Tx power of the PSFCH allocation for the at least one dedicated PSFCH RB; determine at least one of a number or an allocation of a plurality of common PSFCH RBs; and, based upon the corresponding Tx power and the determined number or allocation of the plurality of common PSFCH RBs, calculate Tx power for the plurality of common PSFCH RBs.

Certain example embodiments may be directed to an apparatus that includes means for performing any of the methods described herein including, for example, means for determining a physical sidelink feedback channel allocation for at least one dedicated PSFCH RB; calculating a corresponding Tx power of the PSFCH allocation for the at least one dedicated PSFCH RB; determining at least one of a number or an allocation of a plurality of common PSFCH RBs; and, based upon the corresponding Tx power and the determined number or allocation of the plurality of common PSFCH RBs, calculating Tx power for the plurality of common PSFCH RBs.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

Partial Glossary

| | |
|---|---|
| 3GPP | 3^{rd} Generation Partnership Project |
| 5G | 5^{th} Generation |
| 5GC | 5^{th} Generation Core |
| 6G | 6^{th} Generation |
| ACK | Acknowledgement |
| AF | Application Function |
| AGC | Automatic Gain Control |
| AMF | Access and Mobility Management Function |
| ASIC | Application Specific Integrated Circuit |
| BS | Base Station |
| CAPC | Channel Access Priority Class |
| CBSD | Citizens Broadband Radio Service Device |
| CCA | Clear Channel Assessment |
| CE | Control Elements |
| CN | Core Network |
| COT | Channel Occupancy Time |
| CPU | Central Processing Unit |
| CS | Cyclic Shift |
| CSI | Channel State Information |
| CU | Centralized Unit |
| CW | Contention Window |
| DL | Downlink |
| DMRS | Demodulation Reference Signal |
| DU | Distributed Unit |
| EIRP | Effective Isotropic Radiated Power |
| eMBB | Enhanced Mobile Broadband |
| eNB | Evolved Node B |
| FDM | Frequency Division Multiplexing |
| gNB | Next Generation Node B |
| GPS | Global Positioning System |
| HARQ | Hybrid Automatic Repeat Request |
| HDD | Hard Disk Drive |
| IEEE | Institute of Electrical and Electronics Engineers |
| IoT | Internet of Things |
| L1 | Layer 1 |
| L2 | Layer 2 |
| LBT | Listen Before Talk |
| LTE | Long-Term Evolution |
| LTE-A | Long-Term Evolution Advanced |
| MCS | Modulation and Coding Scheme |
| MEMS | Micro Electrical Mechanical System |
| MIMO | Multiple Input Multiple Output |
| mMTC | Massive Machine Type Communication |
| NACK | Negative Acknowledgement |
| NE | Network Entity |
| NG | Next Generation |
| NG-eNB | Next Generation Evolved Node B |
| NG-RAN | Next Generation Radio Access Network |
| NR | New Radio |
| NR-U | New Radio Unlicensed |
| OCB | Occupied Channel Bandwidth |
| OFDM | Orthogonal Frequency Division Multiplexing |
| PDA | Personal Digital Assistance |
| PRB | Physical Resource Block |
| PSCCH | Physical Sidelink Control Channel |
| PSD | Power Spectral Density |
| PSFCH | Physical Sidelink Feedback Channel |
| PSSCH | Physical Sidelink Shared Channel |
| PUCCH | Physical Uplink Control Channel |
| QoS | Quality of Service |
| RAM | Random Access Memory |
| RAN | Radio Access Network |
| RAT | Radio Access Technology |
| RB | Resource Block |
| RE | Resource Element |
| RF | Radio Frequency |
| ROM | Read-Only Memory |
| RS | Reference Signal |
| Rx | Receiver |
| SCH | Sidelink Shared Channel |
| SCI | Sidelink Control Information |
| SCS | Subcarrier Spacing |
| SL | Sidelink |
| SL-U | Sidelink Unlicensed |
| SMF | Session Management Function |
| TB | Transport Block |
| Tx | Transmitter |
| UE | User Equipment |
| UL | Uplink |
| UMTS | Universal Mobile Telecommunications System |
| UPF | User Plane Function |
| URLLC | Ultra-Reliable and Low-Latency Communication |
| UTRAN | Universal Mobile Telecommunications System Terrestrial |
| | Radio Access Network |
| V2X | Vehicle-to-Everything |
| WLAN | Wireless Local Area Network |

1-24. (canceled)

25. An apparatus comprising:
at least one processor; and
at least one memory storing instructions that, when executed by the at least one processor, cause the apparatus at least to:
determine a physical sidelink feedback channel allocation for at least one dedicated physical sidelink feedback channel resource block;
calculate a corresponding transmission power of the physical sidelink feedback channel allocation for the at least one dedicated physical sidelink feedback channel resource block;
determine at least one of a number or an allocation of a plurality of common physical sidelink feedback channel resource blocks; and
based upon the corresponding transmission power and the determined number or allocation of the plurality of common physical sidelink feedback channel resource blocks, calculate transmission power for the plurality of common physical sidelink feedback channel resource blocks.

26. The apparatus of claim 25, wherein the corresponding transmission power is calculated according to at least one sidelink power control procedure.

27. The apparatus of claim 25, wherein the at least one memory and the instructions, when executed by the at least one processor, further cause the apparatus at least to:
omit transmission of at least one physical sidelink feedback channel common resource block that is located closer to the at least one dedicated physical sidelink feedback channel resource block than at least one threshold.

28. The apparatus of claim 27, wherein the at least one threshold is associated with at least one of a frequency or a number of resource blocks.

29. The apparatus of claim 27, wherein the at least one memory and the instructions, when executed by the at least one processor, further cause the apparatus at least to:
verify whether the physical sidelink feedback channel allocation satisfies at least one occupied channel bandwidth requirement.

30. The apparatus of claim 29, wherein the transmission power for the plurality of common physical sidelink feedback channel resource blocks is calculated such that the transmission power on each of the common physical sidelink feedback channel resource blocks is at least one percent of the total transmission power for common and dedicated physical sidelink feedback channel resource blocks.

31. The apparatus of claim 25, wherein the at least one memory and the instructions, when executed by the at least one processor, further cause the apparatus at least to:
determine whether a calculated total transmit power exceeds a maximum transmission power of the apparatus, wherein the at least one memory and the instructions, when executed by the at least one processor, further cause the apparatus at least to:
firstly omit the transmission of common physical sidelink feedback channel resource blocks that are not the outermost ones, upon determining that the calculated total transmit power exceeds a maximum transmission power of the apparatus; or
reduce the total transmission power of the apparatus and a total dedicated transmission power by an equal amount, until the total transmission power is less than or equal to the total dedicated transmission power, upon determining that the calculated total transmission power either does not exceed the maximum transmission power of the apparatus, or the total transmission power is below a threshold.

32. A method comprising:
determining a physical sidelink feedback channel allocation for at least one dedicated physical sidelink feedback channel resource block;
calculate a corresponding transmission power of the physical sidelink feedback channel allocation for the at least one dedicated physical sidelink feedback channel resource block;
determine at least one of a number or an allocation of a plurality of common physical sidelink feedback channel resource blocks; and
based upon the corresponding transmission power and the determined number or allocation of the plurality of common physical sidelink feedback channel resource blocks, calculate transmission power for the plurality of common physical sidelink feedback channel resource blocks.

33. The method of claim 32, wherein the corresponding transmission power is calculated according to at least one sidelink power control procedure.

34. The method of claim 32, further comprising:
omit transmission of at least one physical sidelink feedback channel common resource block that is located closer to the at least one dedicated physical sidelink feedback channel resource block than at least one threshold.

35. The method of claim 34, wherein the at least one threshold is associated with at least one of a frequency or a number of resource blocks.

36. The method of claim 34, further comprising:
verifying whether the physical sidelink feedback channel allocation satisfies at least one occupied channel bandwidth requirement.

37. The method of claim 36, wherein the transmission power for the plurality of common physical sidelink feedback channel resource blocks is calculated such that the transmission power on each of the common physical sidelink feedback channel resource blocks is at least one percent of the total transmission power for common and dedicated physical sidelink feedback channel resource blocks.

38. The method of claim 32, further comprising:
determining whether a calculated total transmit power exceeds a maximum transmission power of the apparatus, further comprising:
firstly omitting the transmission of common physical sidelink feedback channel resource blocks that are not the outermost ones, upon determining that the calculated total transmit power exceeds a maximum transmission power of the apparatus; or
reducing the total transmission power of the apparatus and a total dedicated transmission power by an equal amount, until the total transmission power is less than or equal to the total dedicated transmission power, upon determining that the calculated total transmission power either does not exceed the maximum transmission power of the apparatus, or the total transmission power is below a threshold.

39. A non-transitory computer readable medium comprising program instructions that, when executed by an apparatus, cause the apparatus to perform at least a method according to claim 32.
